(19) United States
(12) Patent Application Publication
(10) Pub. No.: US 2015/0281409 A1
(43) Pub. Date: Oct. 1, 2015

(54) USING USB OVER IP TO SHARE A NON-USB SENSOR WITH ANOTHER DEVICE

(71) Applicants: Rupesh Tatiya, Bangalore (IN); Neeraj Kandwal, Bangalore (IN); Dzung D. Tran, Beaverton, OR (US)

(72) Inventors: Rupesh Tatiya, Bangalore (IN); Neeraj Kandwal, Bangalore (IN); Dzung D. Tran, Beaverton, OR (US)

(21) Appl. No.: 14/224,343

(22) Filed: Mar. 25, 2014

(51) Int. Cl. H04L 29/06; H04L 29/08

(52) U.S. Cl. CPC H04L 69/26; H04L 67/125

(57) ABSTRACT

Technologies for communicating sensor data from a mobile computing device to a client computing device include a Universal Serial Bus over Internet Protocol (“UoIP”) architecture. The UoIP architecture virtualizes a non-USB sensor device on the mobile computing device as a virtual sensor, and allows the client computing device to recognize the virtual sensor as a USB device. As a result, sensor data obtained by the non-USB sensor device of the mobile computing device can be accessed and used by an application running on the client computing device.

### BACKGROUND

Many existing computing devices (such as desktop, laptop, and notebook computers) are not equipped with integrated sensor hardware, such as motion sensors and mobile pointing devices. However, integrated sensor hardware has become standard in mobile devices, such as smart phones, tablet computers, and wearable devices. The sensor hardware may be “non-USB” in that the sensor hardware is not connected to the electronic device by a Universal Serial Bus (“USB”) connection. There are some applications that can transmit sensor data from a mobile device to an application running on a client device, but this is currently done by a direct network connection rather than a USB connection. As such, current methods require a proprietary application programming interface that is designed for the particular application. For example, some game applications can “sync” movements made on a touch screen of a smart phone with the display of the same game application running on another device (e.g., a laptop computer), but to do so, those game applications require a particular type of browser software and cannot be used with other browsers or with devices that are not both running the same, specialized browser software.

The USB is a specification that was initially developed to facilitate the interconnecting of computing devices, such as personal computers, with peripheral devices, such as printers, scanners, keyboards, and cameras. Subsequently, the USB has been adopted by manufacturers in the consumer electronics and mobile device industries. For example, the USB can be used to connect mobile devices (such as tablet computers) to keyboards and mice, or to connect printers directly to cameras rather than through a personal computer.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a computing system including a client computing device, a mobile computing device, and a Universal Serial Bus over Internet Protocol (UoIP) architecture as disclosed herein;

FIG. 2 is a simplified block diagram of at least one embodiment of an environment of the computing system of FIG. 1;

FIG. 3 is a simplified flow diagram of at least one embodiment of a method for enabling a user-level application on the client computing device of FIG. 1 to access and use sensor data obtained by a non-USB sensor of the mobile computing device of FIG. 1; and

FIG. 4 is a simplified depiction of at least one embodiment of a graphical user interface of a device manager program of the client computing device of FIG. 1, showing an illustrative communication connection to a virtual USB sensor of the mobile device of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (B and C); (A and C); or (A, B, and C). Similarly, items listed in the form of “at least one of A, B, or C” can mean (A); (B); (C): (A and B); (B and C); (A and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

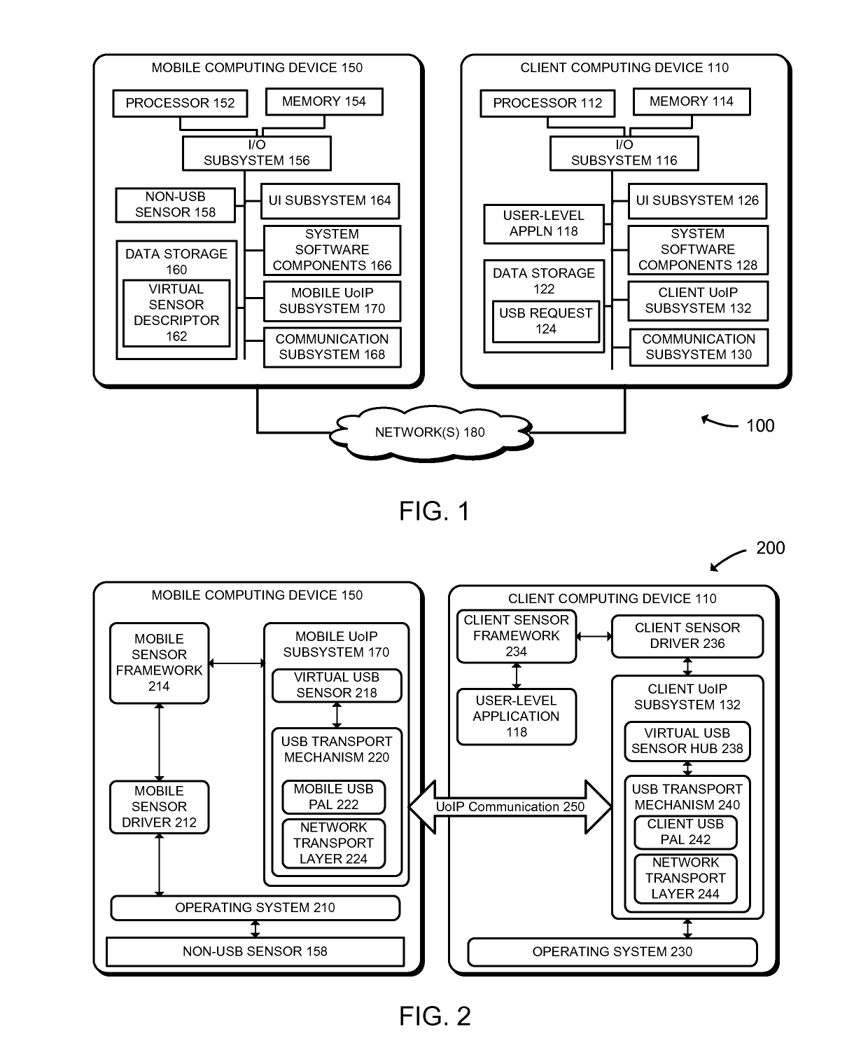

Referring now to FIG. 1, in the illustrative embodiment, a Universal Serial Bus over Internet Protocol (“UoIP”) architecture includes a mobile or “dock” UoIP subsystem 170 and a client UoIP subsystem 132, which are embodied in a mobile computing device 150 and a client computing device 110, respectively, of a computing system 100. The mobile computing device 150 and the client computing device 110 are communicatively coupled by one or more wireless and/or wired networks 180. While illustrated herein as residing on separate devices, the mobile UoIP subsystem 170 and the client UoIP subsystem 132 may reside on the same device, in other embodiments. The illustrative mobile computing device 150 includes a non-USB sensor 158 and the illustrative client computing device 110 is not equipped with such a sensor. For example, the client computing device 110 may be embodied as a “legacy” laptop or personal computer. In other embodiments, however, the client computing device 110 may be equipped with an integrated sensor analogous to the non-USB sensor 158, but use of the non-USB sensor 158 of the mobile computing device 150 may be desirable for other reasons (e.g., to provide greater mobility to the end user vis a vis the client computing device 110 and/or the mobile computing device 150 ). The terms “mobile” and “client” are used herein for clarity in describing the two devices 110, 150; however, it should be understood that either or both devices 110, 150 may be embodied as mobile (e.g., handheld or wearable) devices or other types of computing devices (e.g., servers, laptops, or personal computers), in various implementations of the computing system 100. While the disclosed embodiments refer to the USB specification, it should be understood that aspects of this disclosure are applicable to other types of “plug and play” architectures.

The mobile UoIP subsystem 170 is capable of emulating the non-USB sensor 158 as a virtual USB device (e.g., the virtual USB sensor 218 of FIG. 2). The mobile UoIP subsystem 170 communicates data obtained by the non-USB sensor 158 to the client UoIP subsystem 132 of the client computing device 110 via the virtual USB device, e.g., for use by a user-level application 118 running on the client computing device 110. In operation, as described below, the client computing device 110 can recognize and use the non-USB sensor 158 as if it were an integrated sensor of the client computing device 110 or a USB device connected directly to the client computing device 110. Among other things, the disclosed technologies can enable the client computing device 110 to access and use the non-USB sensor 158 of the mobile computing device 150 as a human interface device in a manner that is transparent to the user-level application 118 (e.g., without needing to modify or recompile the user-level application 118). For example, with the disclosed technologies, the sensor data obtained by the non-USB sensor 158 can be processed by the user-level application 118 without the client computing device 110 or the user-level application 118 knowing that the sensor data was not obtained from local (e.g., integrated or USB-connected) sensor hardware. Additionally, with the disclosed technologies, the sensor data obtained by the non-USB sensor 158 can be used by the client computing device 110 without any need for the mobile computing device 150 to have a copy or counterpart of the user-level application 118 installed and running on the mobile computing device 150. Further, with the disclosed technologies, there is no need for the devices 110, 150 to be equipped with the same operating system or to be running the same browser software. Still further, with the disclosed technologies, there is no need for either of the devices 110, 150 to be equipped with any additional special hardware (e.g., a wireless USB adapter, etc.).

The client computing device 110 may be embodied as any type of device for performing the functions described herein. For example, the client computing device 110 may be embodied as, without limitation, a smart phone, a tablet computer, a wearable computing device, a laptop computer, a notebook computer, a mobile computing device, a cellular telephone, a handset, a messaging device, a vehicle telematics device, a server computer, a desktop computer, a workstation, a distributed computing system, a multiprocessor system, a consumer electronic device, and/or any other computing device configured to perform the functions described herein. As shown in FIG. 1, the illustrative client computing device 110 includes a processor 112, memory 114, an input/output subsystem 116, the user-level application 118, and a data storage device 122, which has embodied therein a USB request 124, described below. The client computing device 110 also includes a user interface subsystem 126, system software components 128, the client UoIP subsystem 132, and a communication subsystem 130. The client computing device 110 may include other or additional components, such as those commonly found in mobile and/or stationary computers (e.g., various sensors and input/output devices), in other embodiments. Additionally, in some embodiments, one or more of the illustrative components may be incorporated in, or otherwise form a portion of, another component. For example, the client UoIP subsystem 132, or portions thereof, may be incorporated in the system software components 128 and/or the communication subsystem 130, in some embodiments.

The processor 112 may be embodied as any type of processor capable of performing the functions described herein. For example, the processor 112 may be embodied as a single or multi-core processor(s), digital signal processor, microcontroller, or other processor or processing/controlling circuit. The memory 114 may be embodied as any type of volatile or non-volatile memory or data store capable of performing the functions described herein. In operation, the memory 114 may store various data and software used during operation of the client computing device 110, such as operating systems, applications, programs, libraries, and drivers. For example, the memory 114 may at least temporarily store portions of the user-level application 118 and/or the USB requests 124.

The memory 114 is communicatively coupled to the processor 112, e.g., via the I/O subsystem 116. The I/O subsystem 116 may be embodied as circuitry and/or components to facilitate input/output operations with the processor 112, the memory 114, and other components of the client computing device 110. For example, the I/O subsystem 116 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 116 may form a portion of a system-on-a-chip (SoC) and be incorporated, along with the processor 112, the memory 114, and/or other components of the client computing device 110, on a single integrated circuit chip.

The user-level application 118 may be embodied as any type of software application that is configured to interface with an end user through a human interface device, such as a keyboard, mouse, or touchscreen. For example, the user-level application 118 may be embodied as a computer game or video game, presentation software, or another type of sensor-based application that can run on the client computing device 110. As used herein, “sensor-based application” may refer to, among other things, software applications that are designed to utilize and/or operate in response to data obtained by a sensor, such as a motion sensor or a pointing device. When embodiments of the client computing device 110 lack the requisite sensor, the disclosed technologies nonetheless enable the use of such user-level applications 118 in a manner that is transparent to the end user.

The data storage device 122 may be embodied as any type of device or devices configured for short-term or long-term storage of data such as, for example, memory devices and circuits, memory cards, hard disk drives, solid-state drives, or other data storage devices. The data storage device 122 may include a system partition that stores data and firmware code for the client computing device 110. The data storage device 122 may also include an operating system partition that stores data files and executables for the system software components 128 (e.g., an operating system) of the client computing device 110.

The user interface subsystem 126 may include a number of devices to facilitate user interaction with the client computing device 110, including physical or virtual control buttons or keys, a microphone, a speaker, a game controller, a unidirectional or bidirectional still and/or video camera, and/or others. The user interface subsystem 126 may also include devices, such as motion sensors, proximity sensors, kinetic sensors, biometric sensors, and/or eye tracking devices, which may be configured to detect, capture, and process various other forms of human interactions involving the client computing device 110.

The system software components 128 include a number of computer program components, such as an operating system, one or more device drivers, and middleware components (e.g., application programming interfaces or APIs, runtime libraries, and/or others). As disclosed herein, portions of the system software components 128 can facilitate the communication between the user-level application 118 of the client computing device 110 and the non-USB sensor 158 of the mobile computing device 150. The client computing device 110 may be equipped with any operating system capable of performing the functions described herein, such as a version of WINDOWS by Microsoft Corporation, a version of LINUX (including ANDROID by Google, Inc. and MEEGO by Intel Corp. and Nokia Corp.), iOS by Apple Computer, Inc., and/or others.

The client UoIP subsystem 132 may be embodied as computer software, hardware, or a combination thereof. As described in more detail below, portions of the client UoIP subsystem 132 interface with the system software components 128 and the mobile UoIP subsystem 170 to allow the client computing device 110 to recognize, or “enumerate,” and connect to the non-USB sensor 158 of the mobile computing device 150 as a USB human interface device. In some embodiments, the client UoIP subsystem 132 may enumerate and connect to other peripheral devices, alternatively or in addition to the non-USB sensor 158.

The client computing device 110 further includes a communication subsystem 130, which may be embodied as any type of communication circuitry, device, or collection thereof, capable of enabling electronic communications between the client computing device 110 and other electronic devices, including the mobile computing device 150. The communication subsystem 130 may be configured to use any one or more communication technologies (e.g., optical, wireless or wired communications) and associated protocols (e.g., Ethernet, BLUETOOTH, WI-FI, WiMAX, 3G/LTE, etc.) to effect such communication. The communication subsystem 130 may be embodied as one or more network adapters, including a wireless network adapter.

The mobile computing device 150 may be embodied as any type of device for performing the functions described herein. For example, the mobile computing device 150 may be embodied as, without limitation, a smart phone, a tablet computer, a wearable computing device, a laptop computer, a notebook computer, a mobile computing device, a cellular telephone, a handset, a messaging device, a vehicle telematics device, a server computer, a workstation, a distributed computing system, a multiprocessor system, a consumer electronic device, and/or any other computing device configured to perform the functions described herein. As shown in FIG. 1, the illustrative mobile computing device 150 includes a processor 152, memory 154, an input/output subsystem 156, the non-USB sensor 158, and a data storage device 160, which has embodied therein a virtual sensor descriptor 162, described below. The mobile computing device 150 also includes a user interface subsystem 164, system software components 166, the mobile UoIP subsystem 170, and a communication subsystem 168. Of course, the mobile computing device 150 may include other or additional components, such as those commonly found in mobile and/or stationary computers (e.g., various sensors and input/output devices), in other embodiments. Additionally, in some embodiments, one or more of the illustrative components may be incorporated in, or otherwise form a portion of, another component. For example, the mobile UoIP subsystem 170, or portions thereof, may be incorporated in the system software components 166 and/or the communication subsystem 168, in some embodiments.

The foregoing description of elements of the client computing device 110 applies to elements of the mobile computing device 150 that have the same or similar name (e.g., processor 112 and processor 152, etc.). Thus, for brevity, the description is not repeated here. However, it should be noted that there is no need for the system software components 166 of the mobile computing device 150 to be the same as or compatible with the system software components 128 of the client computing device 110. For instance, the mobile computing device 150 may be running an ANDROID or iOS operating system with a GOOGLE CHROME or SAFARI web browser, while the client computing device 110 may be running a WINDOWS operating system and an INTERNET EXPLORER browser.

The non-USB sensor 158 may be embodied as a motion sensor device (e.g., an accelerometer, inclinometer, kinetic sensor or proximity sensor), an orientation sensor (e.g., a gyroscope), a mobile pointing device (e.g., an infrared device), a location sensor (e.g., Global Positioning System or GPS), or another type of hardware device that can sense or detect motion (rotational or translational) or position of a person or object. The mobile UoIP subsystem 170 may be embodied as computer software, hardware, or a combination thereof, which enables the sharing of the non-USB sensor 158 over the network 180 as disclosed herein. In some embodiments, the mobile UoIP subsystem 170 may enable the sharing of one or more other peripheral devices, alternatively or in addition to the non-USB sensor 158. As used herein, “peripheral device” may refer to, among other things, a device that generates, obtains, captures or collects data, or performs a service that may be requested by a computer application, and “peripheral device” may include a USB physical device, a virtual USB device, a non-USB device, a “generic” device that may contain a variety of buses and services (e.g., a personal computer, a smart phone, a tablet computer, camera, microphone, touch sensor, etc.), and/or other devices.

The network 180 may be embodied as a cellular network, a local area network, wide area network (e.g., WI-FI), personal cloud, virtual personal network (e.g., VPN), enterprise cloud, public cloud, Ethernet, and/or public network such as the Internet. Alternatively or in addition, the network 180 may enable shorter-range wireless communications between the mobile computing device 150 and the client computing device 110, using, for example, BLUETOOTH and/or Near Field Communication (NFC) technology.

Referring now to FIG. 2, in some embodiments, the computing system 100 establishes an environment 200 during operation. The illustrative environment 200 includes active (e.g., loaded and/or executing) components on both the mobile computing device 150 and the client computing device 110 (e.g., components 210, 212, 214, 218, 220, 230, 232, 234, 236, 238, 240). On the mobile computing device 150, an operating system 210, a mobile sensor driver 212, and a mobile sensor framework 214 are executable components of the system software 166. On the client computing device 110, an operating system 230, a client sensor framework 234, and a client sensor driver 236 are executable components of the system software 128. Further, executable components of the UoIP subsystems 132, 170 are shown in greater detail in FIG. 2. The mobile UoIP subsystem 170 includes a virtual USB sensor 218 and a USB transport mechanism 220, and the USB transport mechanism 220 includes a mobile USB protocol adaptation layer (“PAL”) 222 and a network transport layer 224. The client UoIP subsystem 132 includes a virtual USB sensor hub 238 and a USB transport mechanism 240, and the USB transport mechanism 240 includes a client USB PAL 242 and a network transport layer 244. In some embodiments, the network transport layers 224, 244 may be embodied as components of the system software 166, 128 (e.g., as components of the operating systems 210, 230), respectively, rather than as components of the UoIP architecture 170, 132. For example, the network transport layers 224, 244 may each be embodied as standard operating system-dependent socket-based network transport mechanisms. That is, the implementation of the network transport layers 224, 244 may depend on the operating system(s) with which the devices 150, 110 are provisioned. The various modules of the environment 200 may be embodied as hardware, firmware, software, or a combination thereof. Additionally, in some embodiments, some or all of the modules of the environment 200 may be integrated with, or form part of, other modules or software/firmware structures.

Referring to the mobile computing device 150 as shown in FIG. 2, the illustrative mobile UoIP subsystem 170 can be embodied as a software stack that may be obtained (e.g., downloaded by a user over a network from a web site or an “app store”) and installed as a separate application on the mobile computing device 150. Portions of the mobile UoIP subsystem 170 may be implemented as user mode (e.g., non-privileged) or kernel mode (e.g., privileged) services. Components of the UoIP subsystem 170 communicate with a number of different system software components 166 in order to create the virtual USB sensor 218 on the mobile computing device 150, obtain sensor data from the non-USB sensor 158, and fill requests for the sensor data that are received from the client computing device 110. As noted above, the illustrative virtual USB sensor 218 is a software emulation (or “abstraction”) of the non-USB sensor 158. To create the virtual USB sensor 218, a logical representation of the non-USB sensor 158 is defined and installed on the mobile computing device 150 as a component of the mobile UoIP subsystem 170. To define the logical representation of the non-USB sensor 158, various characteristics of the non-USB sensor 158 (such as the device type, features, type of data, and valid data ranges) are mapped or translated to descriptors or binary codes using, for example, the Universal Serial Bus Human Interface Device (“USB HID”) specification. The logical representation of the non-USB sensor 158 may be stored on the mobile computing device 150 as the virtual sensor descriptor 162, which may be embodied as, for example, an electronic file or data structure. An illustration of a portion of a virtual sensor descriptor 162 is shown in Code Example 1 below.

Code Example 1. Descriptor for Virtual USB Sensor.

HID_USAGE_PAGE_SENSOR,
HID_USAGE_SENSOR_TYPE_MOTION_ACCELEROMETER_3D,
HID_COLLECTION (Physical),
HID_USAGE_PAGE_SENSOR,
HID_USAGE_SENSOR_PROPERTY_REPORTING STATE,
...
HID_USAGE_SENSOR_PROPERTY_SENSOR_STATUS,
HID_FEATURE (Data_Var_Abs),
...
HID_USAGE_SENSOR_DATA
(HID_USAGE_SENSOR_DATA_MOTION_ACCELERATION,
HID_USAGE_SENSOR_DATA_MOD_MAX),
...

In Code Example 1, the virtual USB sensor 218 is defined as a three-dimensional motion accelerometer, and various properties of the sensor are codified using the descriptor language. The virtual USB sensor 218 becomes “active” in response to device enumeration requests from the client UoIP subsystem 132, and may otherwise be inactive in some embodiments. Once the virtual USB sensor 218 is created on the mobile computing device 150, the mobile UoIP subsystem 170 can respond to the device enumeration requests from the client UoIP subsystem 132 by packaging the sensor data (captured by the non-USB sensor 158) according to the virtual sensor specification (e.g., the USB HID motion sensor specification).

To obtain the sensor data for packaging according to the virtual sensor specification (e.g., the USB HID), the mobile UoIP subsystem 170 uses application programming interfaces (APIs) of the mobile sensor framework 214. The particular APIs used to obtain the sensor data from the non-USB sensor 158 may be operating-system dependent. For example, if the mobile computing device 150 is running an ANDROID operating system, the mobile sensor framework 214 may contain SensorManager class APIs, which may be used to obtain the sensor data; whereas if the mobile computing device 150 is running an iOS operating system, the mobile sensor framework 214 may contain CMotionManager class APIs. These APIs of the mobile sensor framework 214 facilitate communication between a mobile sensor driver 212 and the mobile UoIP subsystem 170. For example, the mobile UoIP subsystem 170 may “register” itself with the mobile sensor framework 214, such that the mobile sensor framework 214 periodically sends the motion sensor data captured by the non-USB sensor 158 to the mobile UoIP subsystem 170 (e.g., every few milliseconds), using the relevant APIs. The mobile sensor driver 212 may be embodied as device-specific driver software that enables the operating system 210 to communicate directly with the non-USB sensor 158 to obtain the sensor data from the non-USB sensor 158 and formulate the sensor data for use by the mobile UoIP subsystem 170. The mobile sensor driver 212 interfaces with the operating system 210 and the mobile sensor framework 214 to: communicate sensor data requests to the non-USB sensor 158 in a format that is understandable by the non-USB sensor 158, receive responses from the non-USB sensor 158 (e.g., sensor data), and communicate the non-USB sensor 158's responses to the mobile sensor framework 214. To send the sensor data to the client computing device 110, the mobile USB protocol adaptation layer 222 encapsulates the sensor data according to a USB PAL protocol and the network transport layer 224 sends the encapsulated data to the client computing device 110 as a UoIP communication 250 (using, e.g., a Transmission Control Protocol or “TCP”). The mobile USB PAL 222 provides a logical transport to complete USB transfers between the devices 110, 150 using, e.g., TCP over IP, by mapping USB requests and responses to PAL requests and responses. The mobile USB PAL 222 may be embodied as, for example, a combination of memory management logic, data structures and transfer queues. The USB PAL protocol specification may be defined according to the requirements of a specific implementation of the computing system 100. In some embodiments, portions of the USB PAL protocol may be modeled after the WiGig Serial Extension (“WSE”) PAL specification.

Referring to the client computing device 110 as shown in FIG. 2, the illustrative client UoIP subsystem 132 can be embodied as a software stack that may be obtained (e.g., downloaded by a user over a network from a web site or an “app store”) and installed as a separate application on the client computing device 110. The client UoIP subsystem 132 enables remote (e.g. networked) USB peripherals to be shared with the client computing device 110. Portions of the client UoIP subsystem 132 include software designed to provide the UoIP service and interface with existing USB software as needed. Portions of the client UoIP subsystem 132 may be implemented as user mode (e.g., non-privileged) or kernel mode (e.g., privileged) services. Components of the client UoIP subsystem 132 communicate with a number of different system software components 128 in order to receive requests for sensor data (e.g., USB requests 124) from the user-level application 118, formulate the requests 124 as UoIP communications 250, and send the UoIP communications 250 to the mobile computing device 150 over the network 180. The USB requests 124 populate a data structure that is used by the client sensor driver 236 to submit service requests to the client UoIP subsystem 132

In operation, the user-level application 118 registers itself with the sensor framework 234 and may periodically send USB requests 124 for sensor data to the sensor framework 234. The sensor framework 234 formulates the requests 124 that are received from the user-level application 118 so that they can be read and processed by the USB sensor driver 236. However, instead of interfacing directly with sensor hardware, the USB sensor driver 236 interfaces with the client UoIP subsystem 132. To do this, the USB sensor driver 236 passes the sensor data requests 124 to the client UoIP subsystem 132 in a format that can be read and processed by the client UoIP subsystem 132 (e.g., as USB HID requests).

The virtual USB sensor hub 238 acts as a “slot” to which the virtual USB sensor 218 connects via the USB transport mechanism 220, 240. Accordingly, the virtual USB sensor hub 238 may be embodied as a software emulation of a hardware USB hub interface as described in the USB specifications, which can be accessed at http://www.usb.org/developers/docs/. The virtual USB sensor hub 238 may be embodied as a virtual hub driver or service that: enumerates the virtual USB sensor 218 and/or other USB peripherals, loads the applicable USB client drivers (e.g., the USB sensor driver 236), and translates USB requests 124 from the USB client drivers into requests that can be read and processed by the client USB PAL 242. The client USB PAL 242 encapsulates the USB requests 124 according to the USB PAL protocol and interfaces with the network transport layer 244 to send the requests to the mobile computing device 150 as UoIP communications 250 (using, e.g., the TCP). The encapsulated sensor data requests are sent over the network 180, received at the mobile computing device 150 by the network transport layer 224, decoded by the mobile USB PAL 222, and processed by the mobile computing device 150 as described above.

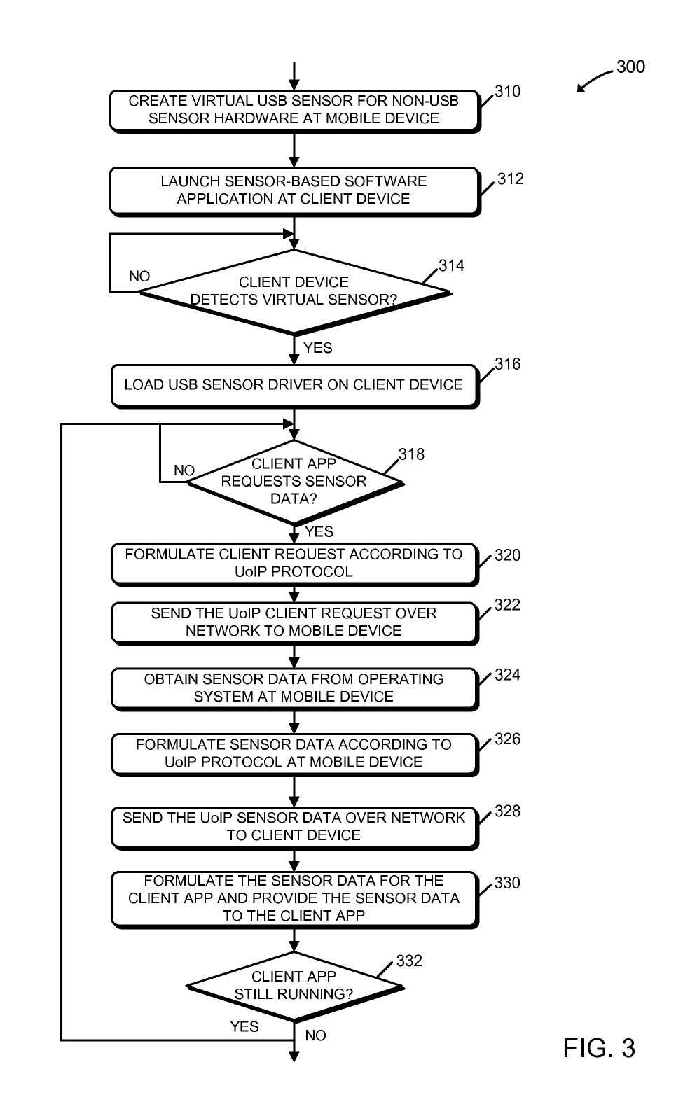

Referring now to FIG. 3, an example of a method 300 for enabling a client application (e.g., the user-level application 118) on the client computing device 110 to access and use sensor data obtained by the non-USB sensor 158 of the mobile computing device 150 is shown. Portions of the method 300 may be executed by the computing system 100; for example, by the client computing device 110 and/or the mobile computing device 150. At block 310, the computing system 100 creates the virtual USB sensor 218 on the mobile computing device 150. To do this, the mobile UoIP subsystem 170 is installed on the mobile computing device 150 and the virtual sensor descriptor 162 is read and executed by the mobile computing device 150. The installation of the mobile UoIP subsystem 170 may be initiated by an end user or by an automated process (e.g., in the event of a software update). At block 312, use of the client application (e.g., a sensor-based application such as the user-level application 118) is initiated on the client computing device 110. To do this, an end user or an automated process may launch the client application (e.g., by tapping or selecting a graphical element on a display screen of the client computing device 110). As part of the launch process, the client application may issue a device enumeration request to identify a sensor that can be used to provide requisite sensor data to the client application during execution of the client application.

At block 314, a determination is made as to whether the client computing device 110 has detected and recognized the virtual USB sensor 218. The virtual USB sensor 218 becomes active and available to transmit sensor data if there is a network connection (e.g., a TCP connection) between the mobile computing device 150 and the client computing device 110, and the mobile computing device 150 (e.g., the mobile UoIP subsystem 170) receives a device enumeration request for the virtual USB sensor 218 from the client computing device 110. If the virtual USB sensor 218 becomes active, the mobile computing device 150 sends a response to the device enumeration request to the client computing device 110. If the client computing device 110 has not detected the virtual USB sensor 218, the method 300 returns to block 314. If the client computing device 110 recognizes the virtual USB sensor 218, the method 300 proceeds to block 316. The receiving by the client computing device 110 of the mobile computing device 150's response to the device enumeration request triggers the loading of the corresponding sensor functional driver (e.g., the client sensor driver 236) by the client computing device 110, at block 316.

At block 318, a determination is made as to whether the client application (e.g., the user-level application 118) has issued a request for sensor data of the kind that can be provided by the non-USB sensor 158 via the virtual USB sensor 218 (e.g., a USB request 124). This determination is answered in the affirmative if the client sensor driver 236 has received a request for sensor data (e.g., “get motion sensor data”) from the user-level application 118. If no such request is received, the method 300 returns to block 318. If a sensor data request has been received from the user-level application 118, client sensor driver 236 formulates the sensor data request as a USB request 124 (e.g., as a USB HID request), and the method proceeds to block 320. At block 320, the client UoIP subsystem 132 formulates the USB request 124 as a UoIP communication 250, using, e.g., a USB PAL protocol as described above. At block 322, the client UoIP subsystem 132 sends the UoIP communication 250 to the mobile computing device 150 using, e.g. a TCP/IP protocol.

At block 324, the mobile UoIP subsystem 170 obtains the requested sensor data from the operating system 210 on the mobile computing device 150. To do this, the mobile UoIP subsystem 170 may interface with the mobile sensor driver 212 via the mobile sensor framework 214. For example, once the mobile UoIP subsystem 170 is registered with the mobile sensor framework 214, the mobile sensor framework 214 may forward sensor data that the mobile sensor driver 212 periodically receives from the non-USB sensor 158 to the mobile UoIP subsystem 170, and the mobile UoIP subsystem 170 may formulate the sensor data as a USB HID response. At block 326, the USB transport mechanism 220 formulates the sensor data (e.g., the sensor data formatted as a USB HID response) as a UoIP communication 250 using, e.g., a USB PAL protocol as described above. Where needed, the mobile UoIP subsystem 170 and/or the client UoIP subsystem 132 perform appropriate conversions of the sensor data from one operating system format to another. For example, the mobile UoIP subsystem 170 or the client UoIP subsystem 132 may apply mathematical formulas to compensate for accelerometer range or references axis differences across the different operating systems that may be used by the mobile computing device 150 and the client computing device 110 (e.g., ANDROID or iOS to WINDOWS, or vice versa). Of course, if both the mobile computing device 150 and the client computing device 110 are running the same operating system, no such conversions may be necessary.

At block 328, the mobile UoIP subsystem 170 sends the sensor data (e.g., the sensor data formatted as a USB HID response) as a UoIP communication 250 to the client computing device 110 using, e.g. a TCP/IP protocol. At block 330, the client UoIP subsystem 132 decodes the UoIP communication 250, forwards the sensor data (e.g., the sensor data formatted as a USB HID response) to the client sensor driver 236, and the client sensor driver 236 provides the sensor data to the user-level application 118 in a format that is usable by the client application (where the format usable by the client application may be implementation-specific), via the client sensor framework 234. At block 332, a determination is made as to whether the client application (e.g., the user-level application 118) is still running on the client computing device 110. If the client computing device 110 determines that the client application is still running, the method returns to block 318 to handle the next request for sensor data. If the client application is not running, the method 300 ends or awaits the subsequent launch of the client application or another sensor-based application.

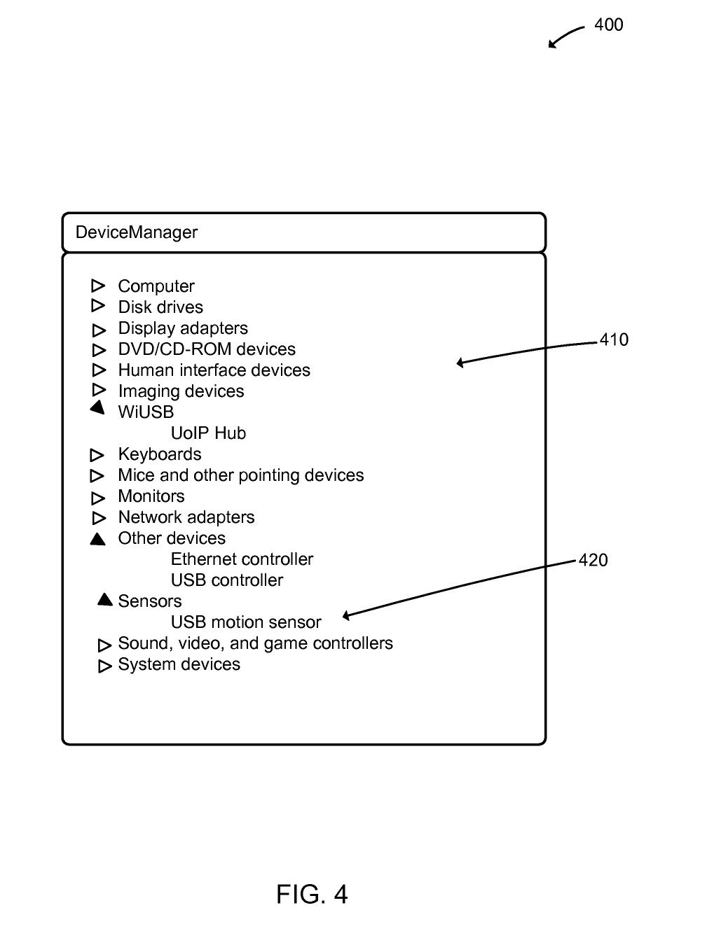

Referring now to FIG. 4, an example of a user interface display screen 400 that may be presented on a display of the client computing device 110 as part of a “Device Manager” utility is shown. The display screen 400 illustrates the recognition by the client computing device 110 of the non-USB sensor 158 as a USB device (the virtual USB sensor 218), or, stated another way, the sharing of the non-USB sensor 158 by the mobile computing device 150 over the network 180. The display screen 400 may be presented to the end user after the client computing device 110 has issued a device enumeration request to the mobile computing device 150 and received a response to the device enumeration request as described above. The illustrative display screen 400 shows a listing 410, which identifies devices that are connected to or in communication with the client computing device 110. The virtual USB sensor 218 is identified at screen location 420 as being connected to the client computing device 110. The display screen 400 and/or the Device Manager may be embodied as part of the user-level application 118, in some embodiments.

### EXAMPLES

Illustrative examples of the technologies disclosed herein are provided below. An embodiment of the technologies may include any one or more, and any combination of, the examples described below.

Example 1 includes a computing device for executing a user-level application using sensor data obtained by a non-Universal Serial Bus (“non-USB”) hardware sensor of a mobile device, where the mobile device is communicatively coupled to the computing device by a network, and the computing device includes a Universal Serial Bus over Internet Protocol (“UoIP”) subsystem communicatively coupled to the user-level application. The UoIP subsystem is to receive a request from the user-level application for the sensor data, recognize the non-USB sensor of the mobile device as a Universal Serial Bus device, and communicate with a UoIP subsystem of the mobile device to receive the sensor data from the mobile device. The computing device further includes a sensor framework communicatively coupled to the UoIP subsystem to formulate the received sensor data for use by the user-level application.

Example 2 includes the subject matter of Example 1, wherein the UoIP subsystem of the computing device includes a transport mechanism and a virtual sensor hub, the transport mechanism is to formulate the request for the sensor data for transmission to the mobile device according to a USB communication protocol and receive the sensor data formulated according to the USB communication protocol, and the virtual sensor hub is to convert the received sensor data to a format usable by the computing device.

Example 3 includes the subject matter of Example 1 or Example 2, wherein the UoIP subsystem of the computing device is to formulate the request for sensor data as a UoIP data read request, send the UoIP data read request to the UoIP subsystem of the mobile device, and receive the sensor data from the UoIP subsystem of the mobile device.

Example 4 includes the subject matter of any of Examples 1-3, wherein the UoIP subsystem of the computing device is to formulate the sensor data received from the UoIP subsystem of the mobile device according to a Universal Serial Bus Human Interface Device specification.

Example 5 includes the subject matter of any of the preceding claims, wherein the UoIP subsystem of the mobile device is to virtualize the non-Universal Serial Bus sensor as a virtual sensor on the mobile device.

Example 6 includes the subject matter of Example 5, wherein the UoIP subsystem of the mobile device is to create the virtual sensor according to a Universal Serial Bus Human Interface Device (“USB HID”) specification.

Example 7 includes the subject matter of Example 6, wherein the UoIP subsystem of the mobile device is to create the virtual sensor by reading a USB HID descriptor file.

Example 8 includes the subject matter of any of the preceding Examples, wherein the UoIP subsystem of the computing device is to send a device enumeration request to the mobile device, the UoIP subsystem of the mobile device is to send a response to the device enumeration request to the UoIP subsystem of the computing device, and wherein the response to the device enumeration request identifies the non-USB sensor of the mobile device to the computing device as a USB device.

Example 9 includes the subject matter of Example 8, wherein in response to the identification of the USB device to the computing device, the computing device is to load a sensor driver corresponding to the virtual USB device, and wherein the sensor driver is in communication with the UoIP subsystem of the computing device.

Example 10 includes the subject matter of any of the preceding Examples, wherein the non-USB sensor of the mobile device includes a motion sensor, the user-level application includes a motion feature responsive to the sensor data, and the UoIP subsystem of the computing device is in communication with the user-level application to operate the motion feature of the application by communicating with the UoIP subsystem of the mobile device.

Example 11 includes a method for enabling execution of a user-level application on a computing device using sensor data obtained by a non-Universal Serial Bus (“non-USB”) hardware sensor of a mobile device, where the mobile device is communicatively coupled to the computing device by a network, including, with the computing device, receiving a request from the user-level application for the sensor data, recognizing the non-USB sensor of the mobile device as a Universal Serial Bus device, communicating with a Universal Serial Bus over Internet Protocol (UoIP) subsystem of the mobile device to receive the sensor data from the mobile device, and formulating the received sensor data for use by the user-level application.

Example 12 includes the subject matter of Example 11, and further includes formulating the request for the sensor data for transmission to the mobile device according to a USB communication protocol, receiving the sensor data formulated according to the USB communication protocol, and converting the received sensor data to a format usable by the computing device.

Example 13 includes the subject matter of Example 11, and further includes formulating the request for sensor data as a UoIP data read request, sending the UoIP data read request to the UoIP subsystem of the mobile device, and receiving the sensor data from the UoIP subsystem of the mobile device.

Example 14 includes the subject matter of Example 11, and further includes formulating the sensor data received from the UoIP subsystem of the mobile device according to a Universal Serial Bus Human Interface Device specification.

Example 15 includes the subject matter of Example 11, and further includes virtualizing the non-Universal Serial Bus sensor as a virtual sensor on the mobile device.

Example 16 includes the subject matter of Example 15, and further includes creating the virtual sensor according to a Universal Serial Bus Human Interface Device (“USB HID”) specification.

Example 17 includes the subject matter of Example 16, and further includes creating the virtual sensor by reading a USB HID descriptor file.

Example 18 includes the subject matter of Example 11, and further includes sending a device enumeration request to the mobile device and sending a response to the device enumeration request to the UoIP subsystem of the computing device, wherein the response to the device enumeration request identifies the non-USB sensor of the mobile device to the computing device as a USB device.

Example 19 includes the subject matter of Example 18, and further includes, in response to the identification of the virtual USB device to the computing device, loading a sensor driver corresponding to the USB device, wherein the sensor driver is in communication with the UoIP subsystem of the computing device.

Example 20 includes the subject matter of Example 11, wherein the non-USB sensor of the mobile device includes a motion sensor, the user-level application includes a motion feature responsive to the sensor data, and the method includes operating the motion feature of the user-level application by communicating with the UoIP subsystem of the mobile device.

Example 21 includes a computing device including memory having stored therein a plurality of instructions that when executed by the computing device cause the computing device to perform the method of any of Examples 11-20.

Example 22 includes one or more machine readable storage media comprising a plurality of instructions stored thereon that in response to being executed result in a computing device performing the method of any of Examples 11-20.

Example 23 includes a computing device comprising means for performing the method of any of Examples 11-20.

Example 24 includes a computing device lacking an integrated motion sensor and configured to execute a motion sensor-based application on the computing device, where the computing device includes a Universal Serial Bus over Internet Protocol (“UoIP”) subsystem to: recognize a non-Universal Serial Bus motion sensor of a mobile device as a Universal Serial Bus human interface device, wherein the mobile device is communicatively coupled to the computing device by a network; receive a request for motion sensor data from the motion-sensor based application; communicate the request for motion sensor data to a Universal Serial Bus over Internet Protocol (“UoIP”) subsystem of the mobile device; and receive the requested motion sensor data from the UoIP subsystem of the mobile device.

Example 25 includes the subject matter of Example 24, wherein the computing device is to formulate the received motion sensor data for use by the motion sensor-based application on the computing device.

Example 26 includes the subject matter of Example 24 or Example 25, wherein the UoIP subsystem of the mobile device is to create the Universal Serial Bus sensor by virtualizing the non-Universal Serial Bus sensor of the mobile device.

Example 27 includes a method for enabling execution of a motion sensor-based application on a computing device that lacks an integrated motion sensor, including, with the computing device: recognizing a non-Universal Serial Bus sensor of a mobile device as a Universal Serial Bus device, wherein the mobile device is communicatively coupled to the computing device by a network; receiving a request for motion sensor data from the motion-sensor based application; communicating the request for motion sensor data to a Universal Serial Bus over Internet Protocol (“UoIP”) subsystem of the mobile device; and receiving the requested motion sensor data from the UoIP subsystem of the mobile device.

Example 28 includes the subject matter of Example 27, and further includes formulating the received motion sensor data for use by the motion sensor-based application on the computing device by converting the received motion sensor data from one operating system format to another operating system format.

Example 29 includes the subject matter of Example 27, and further includes creating the Universal Serial Bus sensor by virtualizing the non-Universal Serial Bus sensor of the mobile device.

Example 30 includes a computing device comprising memory having stored therein a plurality of instructions that when executed by the computing device cause the computing device to perform the method of any of Examples 27-29.

Example 31 includes one or more machine readable storage media comprising a plurality of instructions stored thereon that in response to being executed result in a computing device performing the method of any of Examples 27-29.

Example 32 includes a computing device comprising means for performing the method of any of Examples 27-29.

Example 33 includes a computing device for executing a user-level application using sensor data obtained by a non-Universal Serial Bus (“non-USB”) hardware sensor of a mobile device, where the mobile device communicatively coupled to the computing device by a network, and the computing device includes means for receiving a request from the user-level application for the sensor data; means for recognizing the non-USB sensor of the mobile device as a Universal Serial Bus device; means for communicating with a UoIP subsystem of the mobile device to receive the sensor data from the mobile device; and means for formulating the received sensor data for use by the user-level application.

Example 34 includes the subject matter of Example 33, and includes means for formulating the request for the sensor data for transmission to the mobile device according to a USB communication protocol, means for receiving the sensor data formulated according to the USB communication protocol, and means for converting the received sensor data to a format usable by the computing device.

Example 35 includes the subject matter of Example 33, and includes means for formulating the request for sensor data as a UoIP data read request, means for sending the UoIP data read request to the mobile device, and means for receiving the sensor data from the mobile device.

Example 36 includes the subject matter of Example 33, and includes means for formulating the received sensor data according to a Universal Serial Bus Human Interface Device specification.

Example 37 includes the subject matter of Example 33, and includes means for virtualizing the non-Universal Serial Bus sensor as a virtual sensor on the mobile device.

Example 38 includes the subject matter of Example 37, and includes means for creating the virtual sensor by reading a USB HID descriptor file.

Example 39 includes the subject matter of Example 38, and includes means for sending a device enumeration request to the mobile device, means for sending a response to the device enumeration request to the UoIP subsystem of the computing device, and means for identifying the non-USB sensor of the mobile device to the computing device as a USB device.

Example 40 includes the subject matter of Example 39, and includes means for loading a sensor driver corresponding to the virtual USB device in response to the identification of the USB device to the computing device.

Example 41 includes the subject matter of Example 40, wherein the non-USB sensor of the mobile device comprises a motion sensor, the user-level application comprises a motion feature responsive to the sensor data, and the computing device includes means for communicating with the user-level application to operate the motion feature of the application by communicating with the UoIP subsystem of the mobile device.

1. A computing device for executing a user-level application using sensor data obtained by a non-Universal Serial Bus (“non-USB”) hardware sensor of a mobile device, the mobile device communicatively coupled to the computing device by a network, the computing device comprising:
a Universal Serial Bus over Internet Protocol (“UoIP”) subsystem communicatively coupled to the user-level application, the UoIP subsystem to:
receive a request from the user-level application for the sensor data,
recognize the non-USB sensor of the mobile device as a Universal Serial Bus device, and
communicate with a UoIP subsystem of the mobile device to receive the sensor data from the mobile device; and
a sensor framework communicatively coupled to the UoIP subsystem to formulate the received sensor data for use by the user-level application.

2. The computing device of claim 1, wherein the UoIP subsystem of the computing device comprises a transport mechanism and a virtual sensor hub, wherein the transport mechanism is to formulate the request for the sensor data for transmission to the mobile device according to a USB communication protocol and receive the sensor data formulated according to the USB communication protocol, and the virtual sensor hub is to convert the received sensor data to a format usable by the computing device.

3. The computing device of claim 1, wherein the UoIP subsystem of the computing device is to formulate the request for sensor data as a UoIP data read request, send the UoIP data read request to the UoIP subsystem of the mobile device, and receive the sensor data from the UoIP subsystem of the mobile device.

4. The computing device of claim 1, wherein the UoIP subsystem of the computing device is to formulate the sensor data received from the UoIP subsystem of the mobile device according to a Universal Serial Bus Human Interface Device specification.

5. The computing device of claim 1, wherein the UoIP subsystem of the mobile device is to virtualize the non-Universal Serial Bus sensor as a virtual sensor on the mobile device.

6. The computing device of claim 5, wherein the UoIP subsystem of the mobile device is to create the virtual sensor according to a Universal Serial Bus Human Interface Device (“USB HID”) specification.

7. The computing device of claim 6, wherein the UoIP subsystem of the mobile device is to create the virtual sensor by reading a USB HID descriptor file.

8. The computing device of claim 1, wherein the UoIP subsystem of the computing device is to send a device enumeration request to the mobile device, the UoIP subsystem of the mobile device is to send a response to the device enumeration request to the UoIP subsystem of the computing device, and wherein the response to the device enumeration request identifies the non-USB sensor of the mobile device to the computing device as a USB device.

9. The computing device of claim 8, wherein in response to the identification of the USB device to the computing device, the computing device is to load a sensor driver corresponding to the virtual USB device, and wherein the sensor driver is in communication with the UoIP subsystem of the computing device.

10. The computing device of claim 1, wherein the non-USB sensor of the mobile device comprises a motion sensor, the user-level application comprises a motion feature responsive to the sensor data, and the UoIP subsystem of the computing device is in communication with the user-level application to operate the motion feature of the application by communicating with the UoIP subsystem of the mobile device.

11. A method for enabling execution of a user-level application on a computing device using sensor data obtained by a non-Universal Serial Bus (“non-USB”) hardware sensor of a mobile device, the mobile device communicatively coupled to the computing device by a network, the method comprising, with the computing device:
receiving a request from the user-level application for the sensor data;
recognizing the non-USB sensor of the mobile device as a Universal Serial Bus device;
communicating with a Universal Serial Bus over Internet Protocol (UoIP) subsystem of the mobile device to receive the sensor data from the mobile device; and
formulating the received sensor data for use by the user-level application.

12. The method of claim 11, comprising formulating the request for the sensor data for transmission to the mobile device according to a USB communication protocol, receiving the sensor data formulated according to the USB communication protocol, and converting the received sensor data to a format usable by the computing device.

13. The method of claim 11, comprising formulating the request for sensor data as a UoIP data read request, sending the UoIP data read request to the UoIP subsystem of the mobile device, and receiving the sensor data from the UoIP subsystem of the mobile device.

14. The method of claim 11, comprising formulating the sensor data received from the UoIP subsystem of the mobile device according to a Universal Serial Bus Human Interface Device specification.

15. The method of claim 11, comprising virtualizing the non-Universal Serial Bus sensor as a virtual sensor on the mobile device.

16. The method of claim 15, comprising creating the virtual sensor according to a Universal Serial Bus Human Interface Device (“USB HID”) specification.

17. The method of claim 16, comprising creating the virtual sensor by reading a USB HID descriptor file.

18. The method of claim 11, comprising sending a device enumeration request to the mobile device and sending a response to the device enumeration request to the UoIP subsystem of the computing device, wherein the response to the device enumeration request identifies the non-USB sensor of the mobile device to the computing device as a USB device.

19. The method of claim 18, comprising, in response to the identification of the virtual USB device to the computing device, loading a sensor driver corresponding to the USB device, wherein the sensor driver is in communication with the UoIP subsystem of the computing device.

20. The method of claim 11, wherein the non-USB sensor of the mobile device comprises a motion sensor, the user-level application comprises a motion feature responsive to the sensor data, and the method comprises operating the motion feature of the user-level application by communicating with the UoIP subsystem of the mobile device.

21. One or more machine readable storage media comprising a plurality of instructions stored thereon that in response to being executed result in a computing device:
receiving a request from the user-level application for the sensor data;
recognizing the non-USB sensor of the mobile device as a Universal Serial Bus device;
communicating with a Universal Serial Bus over Internet Protocol (UoIP) subsystem of the mobile device to receive the sensor data from the mobile device; and
formulating the received sensor data for use by the user-level application.

22. The one or more machine readable storage media of claim 21, wherein the instructions result in the computing device formulating the request for the sensor data for transmission to the mobile device according to a USB communication protocol, receiving the sensor data formulated according to the USB communication protocol, and converting the received sensor data to a format usable by the computing device.

23. The one or more machine readable storage media of claim 21, wherein the non-USB sensor of the mobile device comprises a motion sensor, the user-level application comprises a motion feature responsive to the sensor data, and the instructions result in the computing device operating the motion feature of the user-level application by communicating with the UoIP subsystem of the mobile device.

24. A computing device lacking an integrated motion sensor and configured to execute a motion sensor-based application on the computing device, the computing device comprising a Universal Serial Bus over Internet Protocol (“UoIP”) subsystem to:
recognize a non-Universal Serial Bus motion sensor of a mobile device as a Universal Serial Bus human interface device, wherein the mobile device is communicatively coupled to the computing device by a network;
receive a request for motion sensor data from the motion-sensor based application;
communicate the request for motion sensor data to a Universal Serial Bus over Internet Protocol (“UoIP”) subsystem of the mobile device; and
receive the requested motion sensor data from the UoIP subsystem of the mobile device.

25. The computing device of claim 24, wherein the computing device is to convert the received motion sensor data from one operating system format to another operating system format.
